(19) United States
(12) Patent Application Publication
(10) Pub. No.: US 2009/0245056 A1
(43) Pub. Date: Oct. 1, 2009

(54) OPTICAL DISK DEVICE AND CONTROL METHOD

(75) Inventors: Akihiko DOI, Tokyo (JP); Katsumi IZAWA, Yokohama-shi (JP)

Correspondence Address: KNOBBE MARTENS OLSON & BEAR LLP, 2040 MAIN STREET, FOURTEENTH FLOOR, IRVINE, CA, 92614, US

(73) Assignee: KABUSHIKI KAISHA TOSHIBA, Tokyo (JP)

(21) Appl. No.: 12/415,840

(22) Filed: Mar. 31, 2009

(30) Foreign Application Priority Data
Mar. 31, 2008 (JP) 2008-094158

(51) Int. Cl. G11B 20/18

(52) U.S. Cl. 369/53.35; G9B/20.046

(57) ABSTRACT

According to one embodiment, an optical disk device includes a semiconductor laser, a circuit which generates a timing signal to determine a recording pulse timing, a circuit which sets a magnitude of a current for the laser, a circuit which switches the magnitude of the current according to the timing signal, a generation circuit which generates a correction signal from the timing signal to correct response characteristics of a recording pulse, a circuit which synthesizes the correction signal and signals obtained as the switch result to determine the magnitude of the current, and a circuit which feeds the current to the laser according to the synthesis result. The generation circuit extracts high-frequency components from the signals obtained as the switch result and the signal generated by the synthesis circuit, and switches a frequency and a signal gain of each of the components, in accordance with recording pulse conditions.

### CROSS-REFERENCE TO RELATED APPLICATIONS

This application is based upon and claims the benefit of priority from Japanese Patent Application No. 2008-094158, filed Mar. 31, 2008, the entire contents of which are incorporated herein by reference.

### BACKGROUND

1. Field

One embodiment of the present invention relates to an optical disk device which corrects an output waveform of a semiconductor laser, and a control method.

2. Description of the Related Art

In a conventional optical disk device, to perform high-speed recording, as correction of the delay of a laser rise from a recording timing by a filter, a correction pulse is prepared based on a pulse for the recording. Then, a pulse width and a power of the prepared correction pulse are appropriately added to the recording pulse to synthesize a new pulse, by which the laser is emitted (see Jpn. Pat. Appln. KOKAI Publication No. 2006-48885). In consequence, a rise portion is corrected to compensate for the delay of a driver portion in which a current is applied to the laser. Moreover, a filter portion which causes the delay is added to the optical disk device to switch a constant, and an adequate value can also be set in accordance with conditions such as a temperature and a current magnitude.

However, in recent years, further speedup has progressed, and it cannot be considered that a rise of 1.5 ns disclosed in the above document is sufficient, and a rise time less than 1 ns is demanded. Moreover, the smallest recording pulse width of 2 ns or less is demanded. Therefore, in the above method, it is very difficult to adjust the timing of the rise correction pulse, and the timing itself to be compensated further fluctuates owing to the temperature or the like, which makes the sufficient compensation impossible. Moreover, a recording waveform to be prepared in Jpn. Pat. Appln. KOKAI Publication No. 2006-48885 is a simple rectangular waveform, but in the case of the further speeded-up recording, a response speed of a recording medium itself, that is, a speed at which a recording film somehow changes owing to energy obtained from laser light becomes relatively slow. Therefore, it has been necessary to emit the recording pulse itself in such a shape that the delay of the medium itself is compensated. In this case, the control has to be performed by the method disclosed in the document so as to considerably shorten a pulse shift time, and it becomes difficult to stably shift the time. In the method of Jpn. Pat. Appln. KOKAI Publication No. 2006-48885, the recording at a stably high speed cannot be performed. Moreover, even when the filter is switched, the response can merely be delayed. In consequence, optimum conditions cannot be found, and the recording at the stably high speed cannot be performed.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary block diagram showing the configuration of an optical disk device according to one embodiment of the present invention;

FIG. 2 is an exemplary diagram showing the configuration of an automatic power control circuit shown in FIG. 1;

FIG. 3 is a diagram showing a specific constitution example of the automatic power control circuit shown in FIG. 2;

FIG. 4 is a diagram showing a recording example of a mono-pulse system by the automatic power control circuit shown in FIG. 3;

FIG. 5 is a diagram showing a recording example of a multi-pulse system by the automatic power control circuit shown in FIG. 3;

FIG. 6 is an exemplary diagram showing a laser current waveform actually obtained in the recording example of the mono-pulse system shown in FIG. 4;

FIG. 7 is an exemplary diagram showing a laser current waveform actually obtained in the recording example of the multi-pulse system shown in FIG. 5;

FIG. 8 is an exemplary diagram showing a flow for optimizing a pulse correction signal generated by the automatic power control circuit shown in FIG. 3;

FIG. 9 is a diagram showing a configuration example of a general automatic power control circuit;

FIG. 10 is an exemplary diagram showing a laser current waveform obtained for recording by the mono-pulse system in the automatic power control circuit shown in FIG. 9; and

FIG. 11 is an exemplary diagram showing a laser current waveform obtained for recording by the multi-pulse system in the automatic power control circuit shown in FIG. 9.

### DETAILED DESCRIPTION

Various embodiments according to the invention will be described hereinafter with reference to the accompanying drawings.

According to one embodiment of the present invention, there is provided an optical disk device including a semiconductor laser configured to generate laser light to irradiate an optical disk for recording and reproduction; a recording pulse timing generation circuit configured to generate a recording timing signal that determines a recording pulse timing; a laser current setting circuit configured to set a magnitude of a laser current to be fed to the semiconductor laser; a switch circuit configured to switch the magnitude of the laser current in accordance with the recording timing signal; a pulse correction signal generation circuit configured to generate a pulse correction signal that corrects response characteristics of a recording pulse from the recording timing signal; a synthesis circuit configured to synthesize the pulse correction signal and a plurality of signals which are obtained as the switch result of the switch circuit and determine the magnitude of the laser current; and a driving circuit configured to feed the laser current to the semiconductor laser in accordance with the synthesis result of the synthesis circuit, wherein the pulse correction signal generation circuit is configured to extract high-frequency components from the signals obtained as the switch result of the switch circuit and the signal generated by the synthesis circuit, and switches at least one of a frequency and a signal gain of each of the components, in accordance with recording pulse conditions.

According to another embodiment of the present invention, there is provided a control method of an optical disk device which includes a semiconductor laser configured to generate laser light to irradiate an optical disk for recording and reproduction; a recording pulse timing generation circuit configured to generate a recording timing signal that determines a recording pulse timing; a laser current setting circuit configured to set a magnitude of a laser current to be fed to the semiconductor laser; a switch circuit configured to switch the magnitude of the laser current in accordance with the recording timing signal; a pulse correction signal generation circuit configured to generate a pulse correction signal to correct response characteristics of a recording pulse from the recording timing signal; a synthesis circuit configured to synthesize the pulse correction signal and a plurality of signals obtained as the switch result of the switch circuit to determine the magnitude of the laser current; and a driving circuit configured to feed the laser current to the semiconductor laser in accordance with the synthesis result of the synthesis circuit, the method comprising: extracting high-frequency components from the signals obtained as the switch result of the switch circuit and the signal generated by the synthesis circuit; and switching at least one of a frequency and a signal gain of each of the component, in accordance with recording pulse conditions.

In the optical disk device and the control method, a plurality of recording pulse timing signals are combined to generate a recording timing only from a signal which becomes the reference of rise and fall times. Thus, the shift of the pulse timing due to the synthesis can be prevented from being generated. Furthermore, a dull compensation signal for a recording disk can be generated by variably amplifying a signal subjected to alternate-current coupling with the recording pulse timing signal, and setting of an amplification degree of the signal can be switched to an optimum state on various conditions such as an operation environment, an operation speed, a recording power and medium characteristics.

That is, the rise and fall of a pulse emission is improved by providing a correction signal of a rise current in addition to timing adjustment thereof. The frequency characteristics of the correction signal and a signal magnitude are switched to optimum values in accordance with operation conditions such as a temperature and a recording speed, the characteristics of a recording medium and the like. In consequence, a recording pulse waveform can be controlled into such a shape that medium dull characteristics can be compensated, and hence further speedup of the recording can stably be performed.

Hereinafter, an optical disk device according to one embodiment of the present invention will be described with reference to the drawings.

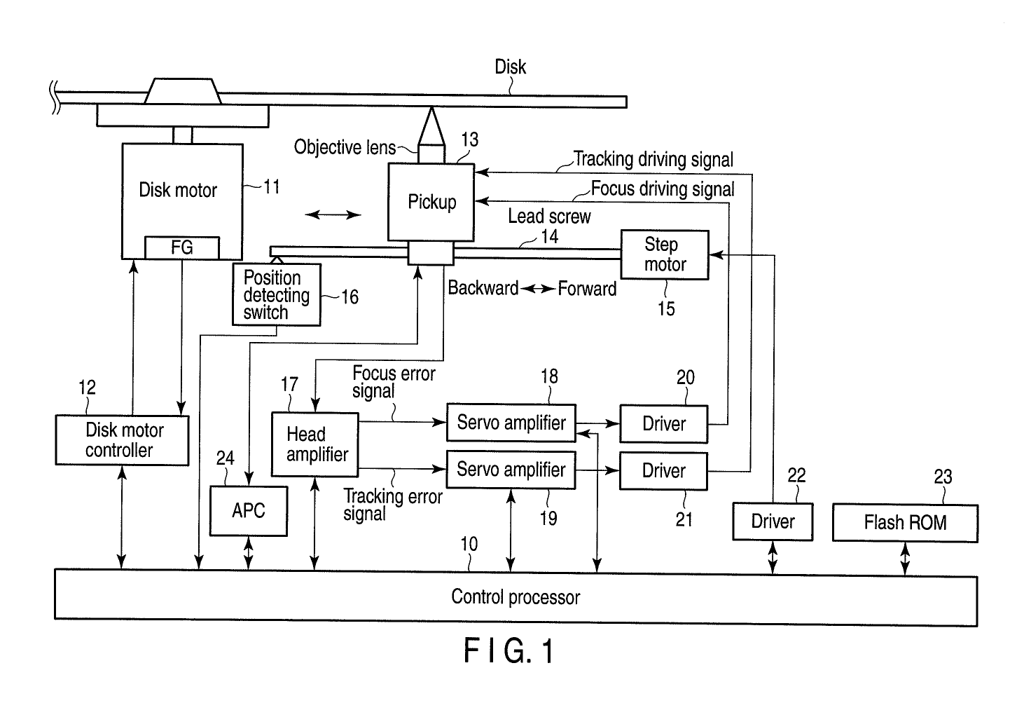

FIG. 1 shows the configuration of the optical disk device. An optical disk is rotatably attached to a disk motor 11. The disk motor 11 is provided with a frequency generator FG. A control processor 10 compares a rotation angle signal from the frequency generator FG with an internal reference frequency to control a disk motor controller 12 so that the disk motor 11 is set to a predetermined rotating direction and a rotation number in accordance with an error signal of the comparison result.

A pickup 13 is provided to face an information recording face of the disk, supported by a sliding shaft (not shown) so as to move in the radial direction of the disk, and moved by a lead screw 14. A step motor 15 is a feed motor of the pickup 13, and a rotary shaft thereof is directly connected to the lead screw 14. A position detecting switch 16 is arranged in a home position of the pickup 13, so hence when the pickup 13 moves to the inner peripheral side of the disk to come in contact with the position detecting switch 16, it is detected that the pickup 13 has reached the home position. The position detecting switch 16 is utilized for the initialization of the position of the pickup 13.

The laser light is divided into three beams by a diffraction grating. The beams are condensed by an objective lens through optical components in the pickup 13, and the thus condensed light irradiates the information recording face of the disk so as to form a spot thereon. The laser light reflected by the disk returns to the objective lens to enter an eight-divided detector through internal optical components (not shown). A focus error signal is of an astigmatism system, and a tracking error signal employs a DPP system. The detector performs current-voltage conversion of the incident light by an IC in the pickup, and outputs a signal of the conversion result to a predetermined head amplifier 17.

The objective lens is supported by a spring, and supported movably in a light axis direction (a focusing direction) of the laser light and the radial direction (a tracking direction) of the disk. Here, coils and magnets are provided to drive the objective lens in the focusing direction and the tracking direction. Such a two-directional movement member is referred to as a biaxial actuator. A focus coil is driven by a focus driving signal output from a driver 20, and a tracking coil is driven by a tracking driving signal output from a driver 21. The drivers 20 and 21 are connected to servo amplifiers 18 and 19, respectively. The servo amplifier 18 is controlled by the control processor 10 to generate the focus driving signal corresponding to the focus error signal from the head amplifier 17. The servo amplifier 19 is controlled by the control processor 10 to generate the tracking driving signal corresponding to the tracking error signal from the head amplifier 17.

The control processor 10 acquires disk address information from a high-frequency (RF) signal or another signal obtained as an information signal from the head amplifier 17 by an unshown CD, DVD, high-density recording DVD demodulator and address decoder. By the control of the step motor 15, the control processor 10 generates two-phase sinusoidal signals, and power-amplifies these signals to output the amplified signals to a driver 22.

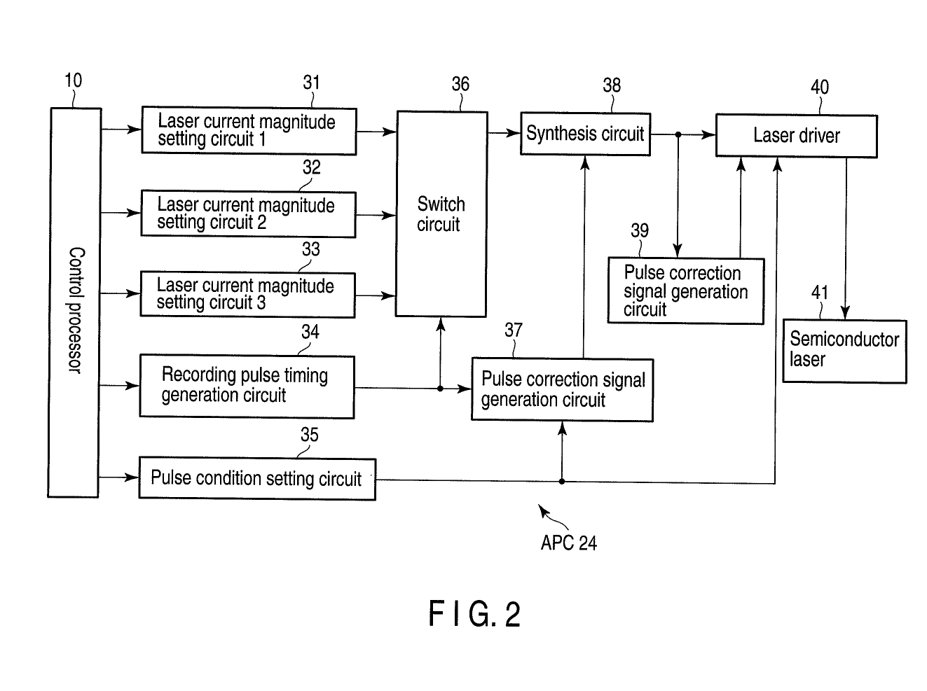

FIG. 2 shows the configuration of an automatic power control circuit 24 shown in FIG. 1. The automatic power control circuit 24 is digitally controlled by the control processor 10 to perform operation setting, and the circuit controls, as the result of the operation setting, a laser output of a semiconductor laser 41 as a laser light source in the pickup 13.

As shown in FIG. 2, the automatic power control circuit 24 includes first to third current setting circuits 31, 32 and 33 in which a laser current magnitude is an operation setting item; a recording pulse timing generation circuit 34 which generates a recording timing signal to determine a recording pulse timing; a pulse condition setting circuit 35 which sets recording pulse conditions; a switch circuit 36 which outputs current magnitude signals from the current setting circuits 31, 32 and 33 in accordance with the timing signal from the recording pulse timing generation circuit 34; a pulse correction signal generation circuit 37 which generates, from the recording timing signal, a pulse correction signal to correct the response characteristics of a recording pulse; a synthesis circuit 38 which superimposes the pulse correction signal from the pulse correction signal generation circuit 37 onto the current magnitude signal from the switch circuit 36; a pulse correction signal generation circuit 39 which generates the pulse correction signal from an output signal of the synthesis circuit 38; and a laser driver 40 which drives the semiconductor laser 41 in response to the output signal of the synthesis circuit 38.

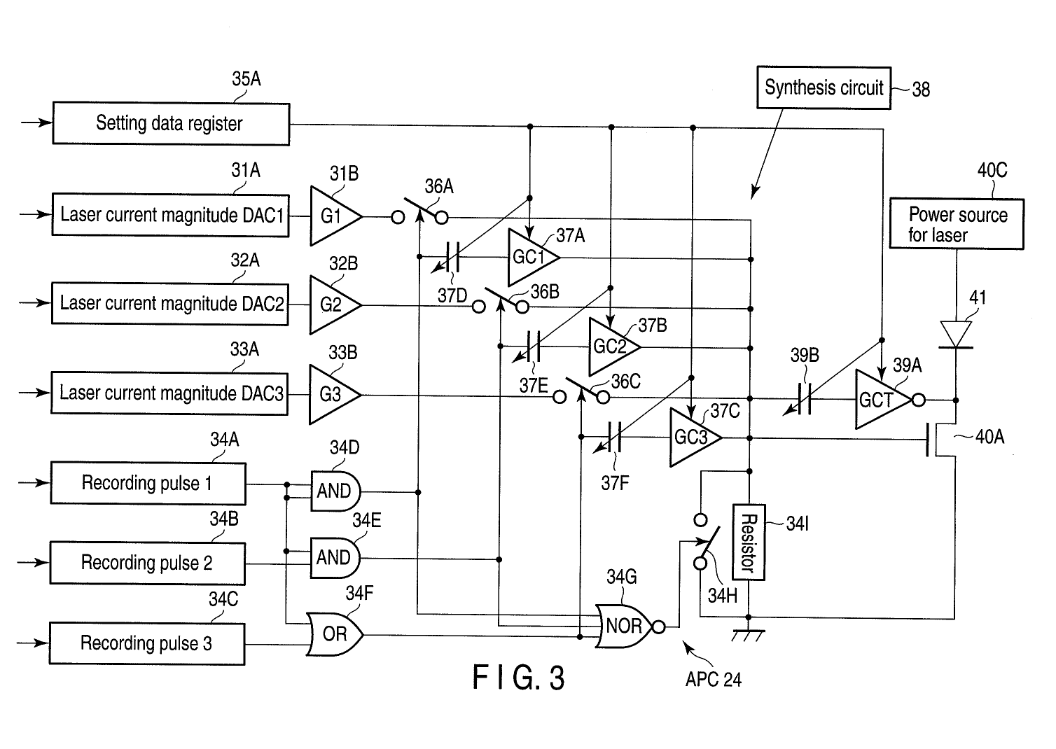

FIG. 3 shows a specific constitution example of the automatic power control circuit 24. Here, the current setting circuit 31 is constituted of a digital-to-analog converter 31A for setting the laser current magnitude and an amplifier 31B, the current setting circuit 32 is constituted of a digital-to-analog converter 32A for setting the laser current magnitude and an amplifier 32B, and the current setting circuit 33 is constituted of a digital-to-analog converter 33A for setting the laser current magnitude and an amplifier 33B. The recording pulse timing generation circuit 34 is constituted of a first recording pulse source 34A, a second recording pulse source 34B, a third recording pulse source 34C, an AND gate 34D, an AND gate 34E, an OR gate 34F, a NOR gate 34G, a switch 34H and a resistor 34I connected as shown in FIG. 3. First and second input ends of the AND gate 34D are connected to an output end of the first recording pulse source 34A, and first and second input ends of the AND gate 34E are connected to an output end of the first recording pulse source 34A and an output end of the second recording pulse source 34B. First and second input ends of the OR gate 34F are connected to the output end of the first recording pulse source 34A and an output end of the third recording pulse source 34C. First to third input ends of the NOR gate 34G are connected to the output ends of the recording pulse sources 34A to 34C. The switch 34H is controlled by the NOR gate 34G. The pulse condition setting circuit 35 is constituted of a setting data register 35A. The switch circuit 36 is constituted of a switch 36A controlled by the AND gate 34D to select the control current setting circuit 31, a switch 36B controlled by the AND gate 34E to select the current setting circuit 32 and a switch 36C controlled by the OR gate 34F to select the current setting circuit 33. The pulse correction signal generation circuit 37 is constituted of variable gain amplifiers 37A to 37C and variable capacitors 37D to 37F. An output end of the AND gate 34D is connected to the variable gain amplifier 37A via the variable capacitor 37D, an output end of the AND gate 34E is connected to the variable gain amplifier 37B via the variable capacitor 37E, and an output end of the OR gate 34F is connected to the variable gain amplifier 37C via the variable capacitor 37F. The synthesis circuit 38 is provided as a wire where output signals from the variable gain amplifiers 37A to 37C are superimposed onto output signals from the switches 36A to 36C. The laser driver 40 includes an MOS transistor 40A and a power source 40C for a laser. The MOS transistor 40A is connected in series with the semiconductor laser 41 between the power source 40C for the laser and the ground, and controlled by an output signal of the synthesis circuit 38. The switch 34H and the resistor 34I are connected in parallel with each other between a gate of the MOS transistor 40A and the ground. The pulse correction signal generation circuit 39 is constituted of a variable gain amplifier 39A and a variable capacitor 39B. The output signal of the synthesis circuit 38 is input into the variable gain amplifier 39A via the variable capacitor 39B, and an output signal of the variable gain amplifier 39A is applied to a node between the semiconductor laser 41 and the MOS transistor 40A. The setting data register 35A is connected so as to control the variable gain amplifiers 37A to 37C, 39A and the variable capacitors 37D to 37F, 39B.

In the above constitution example, the control processor 10 transmits the recording pulse timing indicating a power level of light to be emitted and a period of the emission. Specifically, three types of power levels and periods to maintain these power levels are transmitted by a predetermined rule. Each power level is converted from a digital quantity to an analog laser current magnitude, and the magnitude is amplified together with a gain. These current magnitudes are switched and synthesized by the switch circuit 36 to output each of the current magnitudes for each maintenance period. The laser driver 40 feeds a laser current corresponding to the synthesis result to the semiconductor laser 41.

In this case, the pulse correction signals generated from the recording pulse timing signal and the synthesized signal are applied to the synthesis circuit 38 and the laser driver 40.

The recording pulse timing generation circuit 34 generates the timing signal from a logical product of a recording pulse 1 of the recording pulse source 34A and a recording pulse 2 of the recording pulse source 34B, and a logical sum of the recording pulse 1 and a recording pulse 3 of the recording pulse source 34C based on the recording pulse 1 of the first recording pulse source. Here, the timing of the recording pulse 1 is adjusted by obtaining the logical product by the same signal so that the recording pulse is delayed as in another signal.

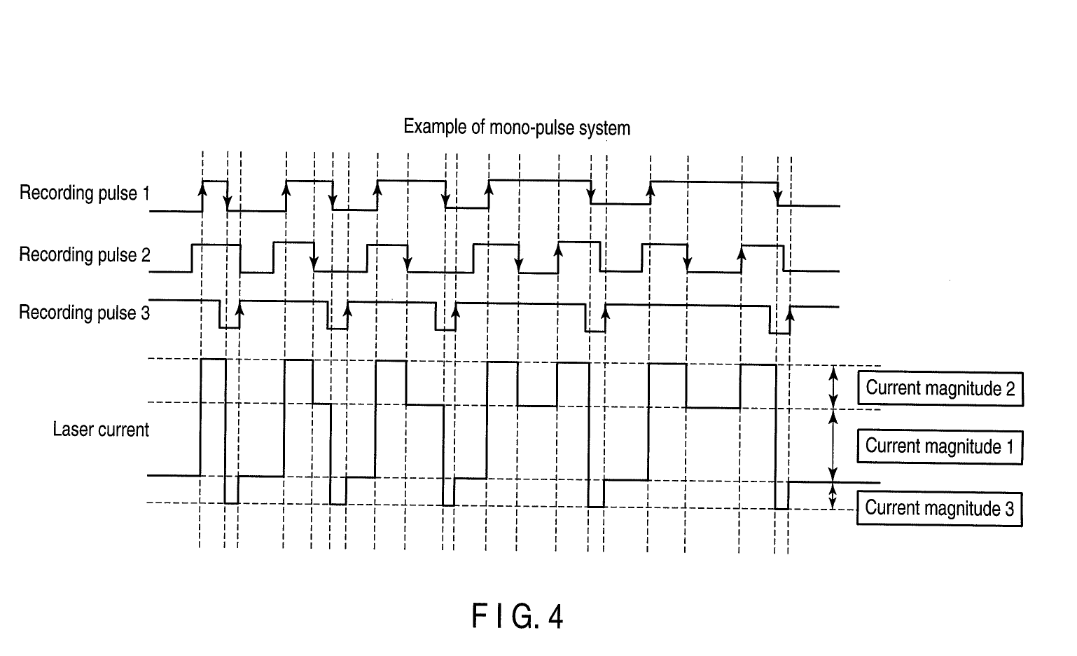

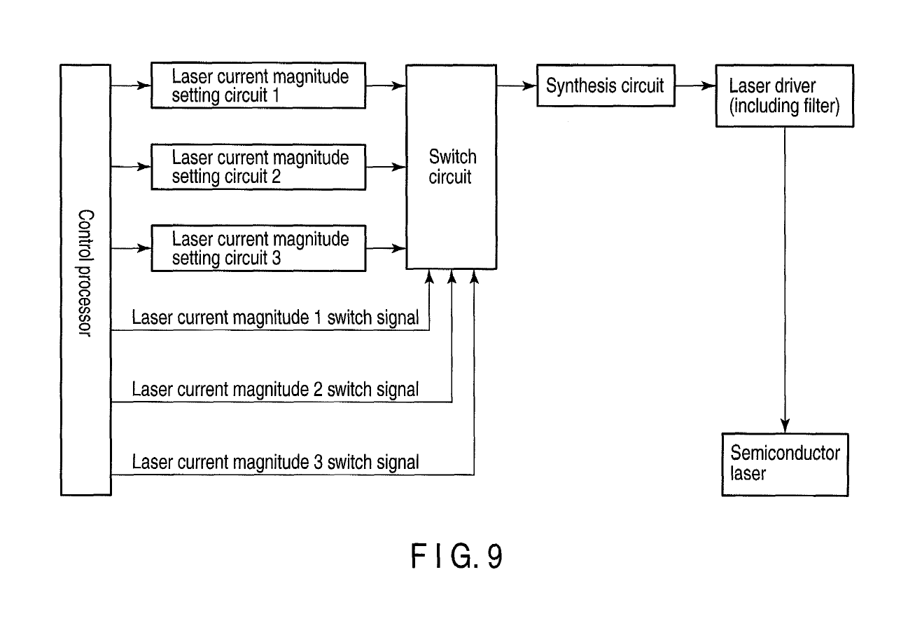

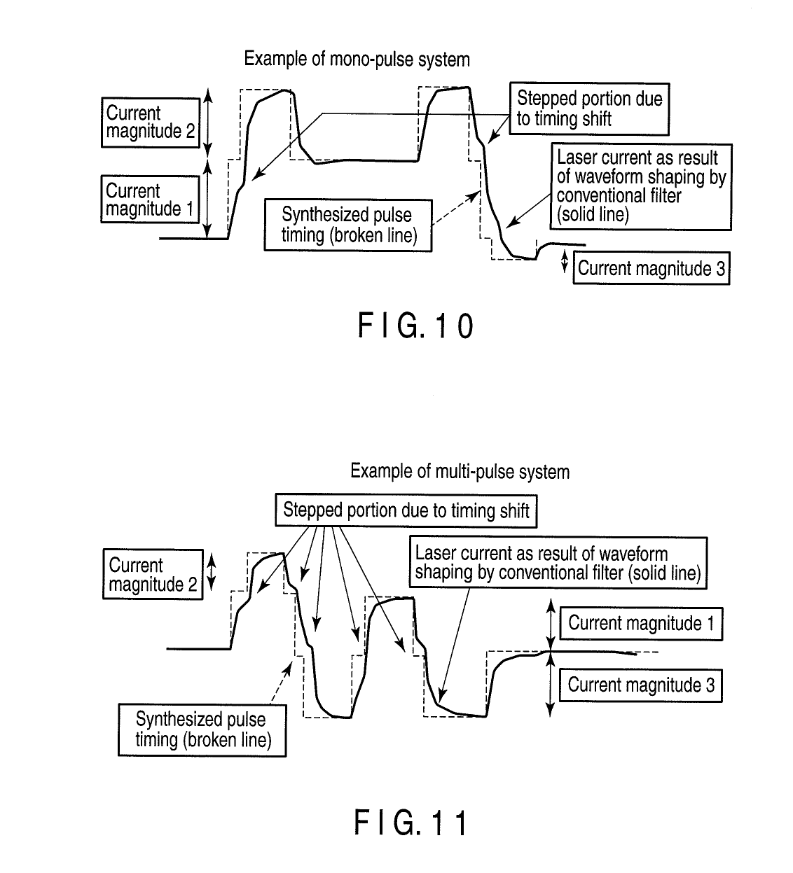

FIG. 4 shows a recording example of a mono-pulse system. The laser current is set in accordance with the recording pulses 1, 2 and 3 as shown in FIG. 4, and the logical product is taken so that the recording pulses 1, 2 simultaneously turn on and off at the start of writing of a mark and at the end of the writing, to determine rise and fall of the recording pulse 1 only by the edges. Moreover, as to the last short off portion of the mark, the logical sum is taken to determine the fall by the recording pulse 1 and determine the rise by the recording pulse 3. Furthermore, a timing to change the power in the middle of the recording mark is determined by the recording pulse 2. In a general case where the configuration shown in, for example, FIG. 9 is employed and two signals are independently transmitted to change two switches, respectively, thereby synthesizing the signals, as shown in FIG. 10, small time shift is generated between two pulses. In consequence, a current waveform is a staircase-like waveform. This is prevented in a laser current waveform shown in FIG. 4. Moreover, the switching is performed at one pulse timing, and hence the rise or fall of the pulse at the timing to change the level as described later can easily be corrected.

As to the laser current magnitude, the output signals of the digital-to-analog converters 31A, 32A and 33A obtained as the setting result of the control processor 10 are amplified together with gains. Moreover, these output signals are switched at the recording pulse timing to output each output signal for each predetermined period. These signals are synthesized as a current signal by the resistor, and converted into a voltage. This voltage is supplied to the transistor 40A of the laser driver 40, and the laser current changes in accordance with this signal.

Here, the pulse correction signal generation circuit 37 will be described. When the laser current magnitude setting signals are switched and synthesized using the recording pulse timing generation circuit 34, the AC coupling variable capacitors 37D to 37F and variable gain amplifiers 37A to 37C extract a high-frequency component only from each laser current magnitude setting signal. Here, operations of the variable capacitors 37D to 37F can be switched, and the frequency can be set to an adequate frequency such as a double speed. Moreover, a signal correction degree is set so that the waveform emitted from the semiconductor laser 41 finally becomes adequate. The switches 36A to 36C are constituted so that each switch turns on at a time when a switch signal has a high level. In a case where the AC coupling is performed, the component can be extracted as a signal having a plus direction in a state in which the switch turns on, and the component can be extracted as a signal having a minus direction in a state in which the switch turns off. When the switch turns on with respect to the synthesis circuit 38, this signal only is corrected and rises early. When the switch turns off, this signal only falls fast, and the fall can be corrected. Moreover, the resistor 34I serves as a filter, and is therefore provided for preventing the speed from lowering in a case where the switch 34I turns off the semiconductor laser 41. In general, when the semiconductor laser 41 is completely turned off (the current is made zero), characteristics in a case where the laser is turned on become unstable, and hence a bias current is fed to such an extent that the light is slightly emitted.

Next, the pulse correction signal generation circuit 39 will be described. In the pulse correction signal generation circuit 39, the driving signal of the transistor 40A is AC-coupled by the variable capacitor 39B, the gain is set to an adequate gain by the variable gain amplifier 39A, and polarity is inverted in accordance with the fluctuating polarity of a forward voltage during the driving of the laser, to output the signal to the semiconductor laser 41. In consequence, in the semiconductor laser 41, a correction signal operates in a direction in which the level fluctuates, and the rise and fall times decrease.

Here, a specific process for preparing a laser current waveform will be described. In the case of the mono-pulse system, the recording pulse 1 shown in FIG. 4 determines the rise and fall signals of the recording mark, the recording pulse 2 determines a signal indicating that a peak pulse turns off or on in the mark, and the recording pulse 3 determines the timing of a cool pulse in a final portion. Significant timings are shown by arrows.

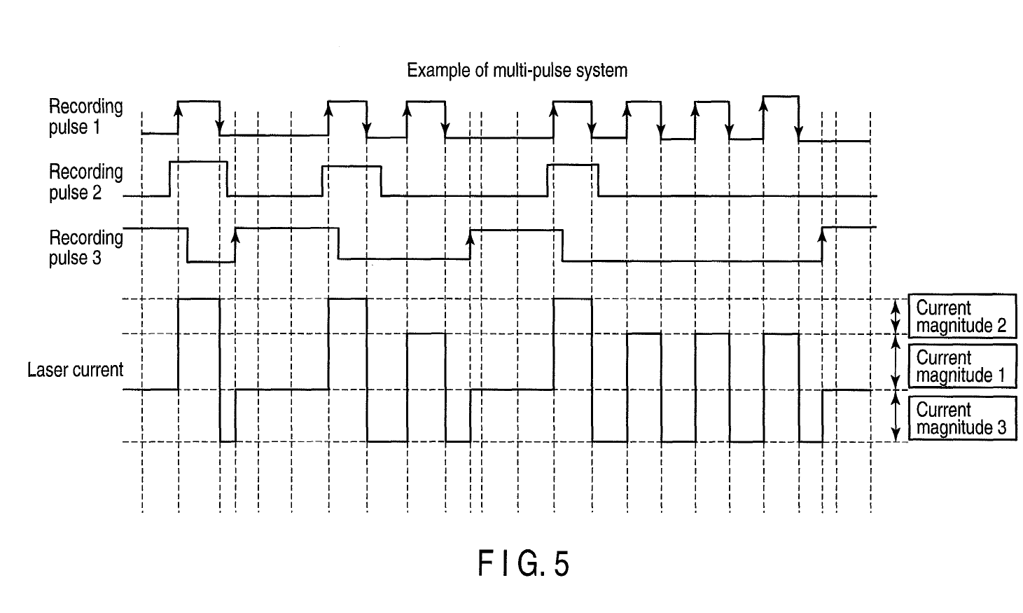

In the case of the multi-pulse system shown in FIG. 5, in the same manner as described above, the recording pulse 1 determines the rise and fall signals of the recording mark, and the recording pulse 3 determines the timing of the cool pulse in the final portion.

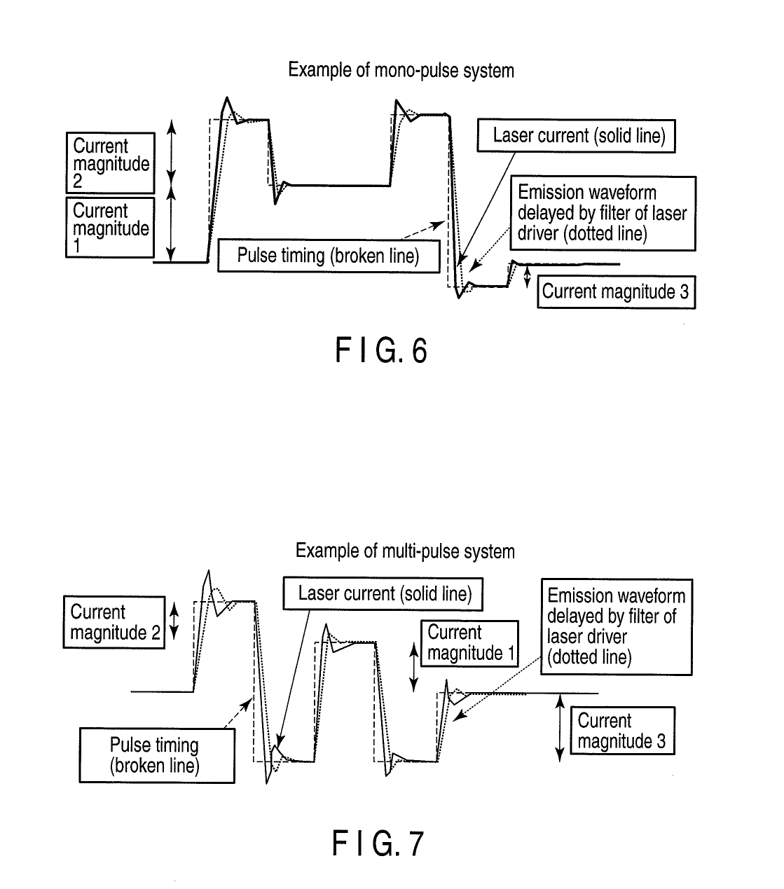

FIG. 6 shows a laser current waveform actually obtained for the recording in the mono-pulse system, and FIG. 7 shows a laser current waveform actually obtained for the recording in the multi-pulse system. A broken line indicates an ideal signal, a solid line indicates a driving circuit current in a case where the above-mentioned pulse correction signal is set to an adequate signal, and a dotted line indicates the laser light actually output from the semiconductor laser 41 having an impedance and therefore operating as a low pass filter.

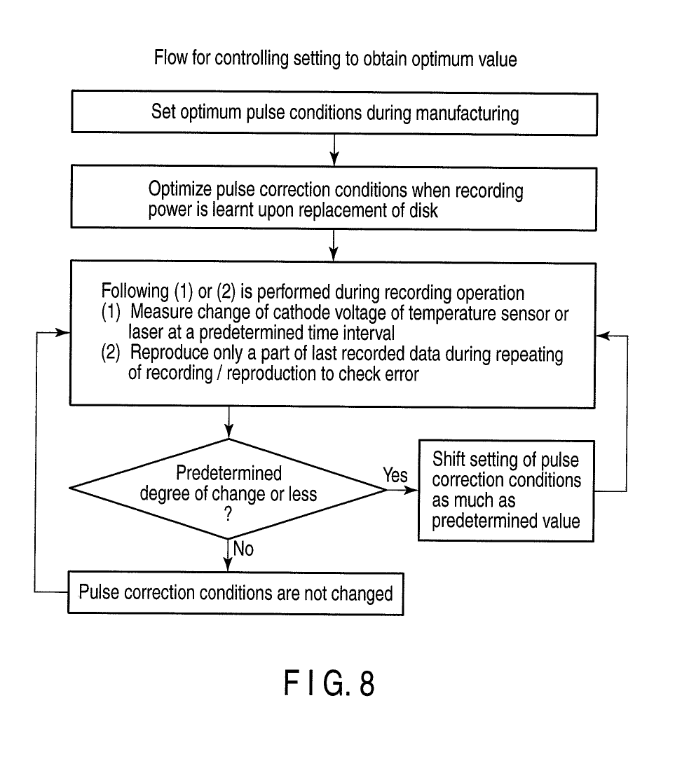

Next, an adjustment method of the pulse correction signal will be described. FIG. 8 shows a flow for optimizing the pulse correction signal.

First, characteristics deteriorate owing to parasitic elements generated from the pickup, the laser, a substrate and the like during device manufacturing. Therefore, an adequate value to be corrected is obtained from a waveform during the manufacturing, and the value is set as a reference value.

Next, a time when the recording is actually performed will be described. When a disk for the recording is inserted into a device, data is actually written on trial to set a condition such as a recording power. A learning function is provided in this manner. If a bad recording result is obtained, the correction conditions are adjusted based on the reference value to obtain an optimum point.

Next, a correction process in a case where the recording is performed in a drive will be described. If a sensor capable of detecting a temperature in the vicinity of the semiconductor laser 41 is disposed, an environmental temperature can be known from an output of the sensor. The delay of the pulse is necessary, as a laser temperature is high and a current magnitude is large. Therefore, the degree to which the characteristics change is obtained, and the set value may be changed in accordance with the degree to which the temperature changes. Moreover, the setting may be changed in accordance with the value of the current to be fed. Additionally, in a case where any temperature sensor is not disposed, a signal from which the change of the operation voltage of the laser in a forward direction can be detected is monitored. As shown in FIG. 3, when the power source 40C for the laser is connected to an anode of the semiconductor laser 41 and the transistor 40A is connected to a cathode of the semiconductor laser 41, a cathode voltage may be measured. This voltage also changes in accordance with the temperature or the total magnitude of the current. Therefore, a relation between this voltage and the correction value is obtained, and the value may be corrected in accordance with the voltage value.

Next, a method for performing the correction from the actually recorded data will be described.

In the case of an optical disk, when the data is actually recorded, the data is recorded at a speed higher than that of data transmitted from a host computer. Therefore, in an actual operation, a certain group of data is recorded, the recording is once discontinued to store the recorded data, and then the recording is performed again. In this case, a part of the last recorded data is reproduced, and an error ratio or the like is checked. If the ratio or the like deteriorates, the setting of the pulse correction is changed. In this case, a temperature rise basically raises a problem. In consequence, it is known that when the data continues to be written for a long time, the temperature rises, and the error ratio is generated. Therefore, a setting direction is a direction in which further correction is performed.

Even when the control is performed in this manner and the temperature or the current magnitude accordingly varies, the recording can be performed stably at a high speed.

It is to be noted that in the present embodiment, the laser driver 40 is connected to a cathode side of the semiconductor laser to operate the same. However, even in the laser driver 40 in which, for example, the anode is connected to the driver 40 and the cathode is connected to the ground, the similar correction is possible. However, the polarity of the pulse correction signal in a laser driver 40 stage during the connection is opposite to that of the above embodiment, that is, the laser driver may be connected in the forward direction. Moreover, the parasitic element of the semiconductor laser 41, the substrate or the like has characteristics which vary in accordance with a wavelength. To solve the problem, the filter is connected to the semiconductor laser 41 so that the parasitic element has the same characteristics in each laser. However, the pulse correction signal may be set in consideration of the characteristics.

In general, when a power source for the laser driver 40 is finite and there is not any allowance in the voltage, speed performance deteriorates. As a current flows in large quantities and the temperature is high, the performance of the semiconductor laser 41 remarkably deteriorates. On the other hand, generally during high double speed recording in the device, an internal circuit operates fast, and hence the power increases. Eventually, the generation of heat increases, with the result that the temperature rises. In this case, the pulse correction signal generated from the timing signal of the recording pulse as described above is added, whereby the response characteristics of a power changing portion in the recording current of the laser are stabilized, irrespective of the change in the temperature and the current to be fed. Accordingly, the speedup of the recording can be realized.

The various modules of the systems described herein can be implemented as software applications, hardware and/or software modules, or components on one or more computers, such as servers. While the various modules are illustrated separately, they may share some or all of the same underlying logic or code.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An optical disk device comprising:
a semiconductor laser configured to emit laser light to irradiate an optical disk for recording and reproduction;
a recording pulse timing generator configured to generate a recording timing signal indicating a recording pulse timing;
a laser current configuration circuit configured to set a magnitude of a laser current to be fed to the semiconductor laser;
a switch configured to switch the magnitude of the laser current in accordance with the recording timing signal;
a first pulse correction signal generator configured to generate a pulse correction signal configured to correct response characteristics of a recording pulse from the recording timing signal;
a synthesizer configured to synthesize the pulse correction signal and a plurality of signals of the switch result of the switch and to determine the magnitude of the laser current; and
a driving circuit configured to feed the laser current to the semiconductor laser in accordance with the synthesis result of the synthesizer;
wherein the pulse correction signal generator is configured to extract high-frequency components from the signals of the switch result of the switch and the signal generated by the synthesizer, and to switch at least one of a frequency and a signal gain of each of high-frequency component in accordance with recording pulse conditions.

2. The optical disk device of claim 1, wherein the pulse correction signal generator is configured to generate the signals extracted from the signals of the switch result of the switch, and to set at least one of the frequency and the gain extracted from the signals independently, and the synthesizer is configured to synthesize the signals with the signals of the switch result of the switch.

3. The optical disk device of claim 1, further comprising a second pulse correction signal generator wherein the second pulse correction signal generator is configured to extract the high-frequency components from the signal generated by the synthesizer, to switch the configuration of at least one of the frequency and the signal gain of the high-frequency component in accordance with the recording pulse conditions, and to add the generated signal to a laser driving signal in the driving circuit.

4. The optical disk device of claim 1, further comprising a pulse condition setting circuit, wherein the frequency and the signal gain of the pulse correction signal generator are preset to substantially optimum conditions, and the pulse condition setting circuit is configured to detect whether the preset values are substantially optimum when the recording pulse conditions are computed, and to reset the set values to optimum values.

5. The optical disk device of claim 1, wherein a portion of the last written data is reproduced during the reproduction when the recording and the reproduction are repeated, and the pulse correction signal generator is configured to change the setting conditions by a predetermined value when a change in an error rate equal to or greater than a predetermined value is received.

6. The optical disk device of claim 1, further comprising:
a temperature sensor configured to measure a temperature indicative of the temperature of the semiconductor laser,
wherein the pulse correction signal generator is configured to change the setting conditions to predetermined values, in accordance with a measurement result.

7. The optical disk device of claim 1, further comprising:
a monitor configured to monitor a voltage applied to the semiconductor laser,
wherein the pulse correction signal generator is configured to change the setting conditions to predetermined values in accordance with a monitoring result.

8. A control method of an optical disk device which comprises:
a semiconductor laser configured to emit laser light to irradiate an optical disk for recording and reproduction;
a recording pulse timing generator configured to generate a recording timing signal indicating a recording pulse timing;
a laser current configuration circuit configured to set a magnitude of a laser current to be fed to the semiconductor laser;
a switch configured to switch the magnitude of the laser current in accordance with the recording timing signal;
a pulse correction signal generator configured to generate a pulse correction signal configured to correct response characteristics of a recording pulse from the recording timing signal;
a synthesizer configured to synthesize the pulse correction signal and a plurality of signals of the switch result of the switch and to determine the magnitude of the laser current; and
a driving circuit configured to feed the laser current to the semiconductor laser in accordance with the synthesis result of the synthesizer, the method comprising:
extracting high-frequency components from the signals of the switch result of the switch and the signal generated by the synthesizer; and
switching at least one of a frequency and a signal gain of each of the high-frequency components, in accordance with recording pulse conditions.
